(19) United States
(12) Patent Application Publication
(10) Pub. No.: US 2003/0005327 A1
(43) Pub. Date: Jan. 2, 2003

(54) System for protecting copyrighted materials

(76) Inventors: Julian Durand, Cambridge, MA (US); Kimmo Djupsjobacka, Palo Alto, CA (US); Pekka Koponen, Espoo (FI); Tommy Arnberg, Espoo (FI); Jari Vaario, Beijing (CN); Piotr Cofta, Helsinki (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/893,589

(22) Filed: Jun. 29, 2001

(51) Int. Cl. H04L 9/00

(52) U.S. Cl. 713/201; 713/168

(57) ABSTRACT

A system for protecting copyrighted materials which are digitally transferred. A terminal is wirelessly connected to a server, digital rights management engine and content storage device. After the user is authenticated, the server gains authorization to forward the content to the user. By having almost all functions in the secure area of the server, illegal copying is less likely to occur.

### BACKGROUND OF THE INVENTION

1. Field of the Invention

This invention relates generally to a communications system which protects copyrighted materials and more particularly to a wireless communications system having a secure server which protects copyrighted materials.

2. Description of the Prior Art

The arrival of the information age has encouraged the free flow of information among people. Connections to the Internet are now very common so that it is possible for even children to obtain information from many sources and pass it along to others. While this is generally considered to be a good thing, such benefits also have some problems. Thus, there are problems of hackers trying to obtain access to secure systems, children having access to material which is improper for their age and the inevitable problem of improper copying of copyrighted materials.

In regard to copyrighted material, the reproduction of digital data is so simple and produces such a good copy that unauthorized copying is happening more frequently. Especially in view of programs such as NAPSTER, the improper copying of music and other works has become a source of lost sales to data sources such as record labels.

Thus, attempts have been made to find systems which allow for easy transfer of copyrighted digital data while retaining control over copying in order to prevent loss of revenue by unauthorized copying. Companies exist which have systems by which copyright may be protected in wired networks of PC's. However, such systems are not usable in wireless networks. In particular, they are not useful in a wireless network with an “always on” connection. This is a GPRS(General Packet Radio Service) type of connection that charges by data “quantity” (packet charging) rather than time on line. This type of network allows the user to have the device on and connected to the network for long periods of time. This is economical is the traffic is low as in the case of digital rights management (DRM) control.

In order for current systems to work, they must either completely trust the end user or must have a terminal with a high level of storage and processing capability in order to handle the special systems, such as encryption, that are necessary. This provides a great disadvantage for wireless devices which must be small and simple in order to keep them inexpensive and portable.

Various other systems have been proposed in order to protect rights in digital data. For example, U.S. Pat. No. 5,982,891 shows a system for a virtual distribution environment. In this system, the content is sent in an encrypted or otherwise protected form which requires a key. Controls are also provided which determine how the keys may be used. These keys and controls travel to a secure environment before they can be accessed and processed.

Another system is shown in U.S. Pat. No. 6,014,651. In this system, a customer computer is connected to an on line service provider by telephone, Internet or through a wireless link. The customer has access to additional processing and storage resources in the service providers system.

Another system is shown in U.S. Pat. No. 6,061,790. A user may access a machine which is connected to a network but which does not know the user. By using the password of the user, the machine is able to initiate a communication session and identify the user.

U.S. Pat. No. 5,724,425 shows a method for enhancing software security. A protected code may be stored in an encrypted format in a passport.

U.S. Pat. No. 5,638,443 shows a system for controlling the distribution of digital works. Control information is added to the actual content. Work is organized logically in a tree structure having nodes.

U.S. Pat. No. 5,943,422 shows a system for encoding rights management control signals onto an information signal. The control information is carried invisibly.

While these and other systems can operate in various circumstances, they do not work well with a wireless network in an “always on” connection. Further, even stronger protections are necessary to protect copyright royalties and to prevent hackers from breaking into systems.

### SUMMARY OF THE INVENTION

Accordingly, the present invention provides a system for protecting content in a wireless network.

The present system also provides protection for copyrighted content in a wireless network having an “always on” connection.

This system further provides for protection of copyrighted material in a wireless network where trusted execution and digital rights management services run on the server.

The system still further provides for protection of content in a wireless system using mutual authentication, request, authorization and recording in an audit trail.

Briefly, the present invention provides this by having a secure server which communicates with a wireless terminal. After the terminal and server have been authenticated, the execution and digital rights management services run on the server to obtain authorization to send copyrighted material to the terminal. Audit trails are generated in the trusted environment as well.

### BRIEF DESCRIPTION OF THE DRAWINGS

A more complete appreciation of the invention and many of the attendant advantages thereof will be readily attained as the same becomes better understood by reference to the following detailed description when considered in connection with the accompanying drawings, wherein:

FIG. 1 shows a block diagram of the system in a first embodiment;

FIG. 2 is a block diagram showing the present invention in a second embodiment;

FIG. 3 is a flowchart showing the steps utilized in the first embodiment of the present invention;

FIG. 4 is a flowchart showing the steps of the second embodiment of the present invention;

FIG. 5 shows a block diagram of another arrangement of the system of the present invention.;

FIG. 6 is a diagram showing the arrangement of data in the storage device;

FIG. 7 is a diagram showing the storage of data in the digital rights management engine;

FIG. 8 is a diagram showing the storage of data in the audit trail storage device; and

FIG. 9 is a diagram showing the storage of event data.

### DESCRIPTION OF THE PREFERRED EMBODIMENTS

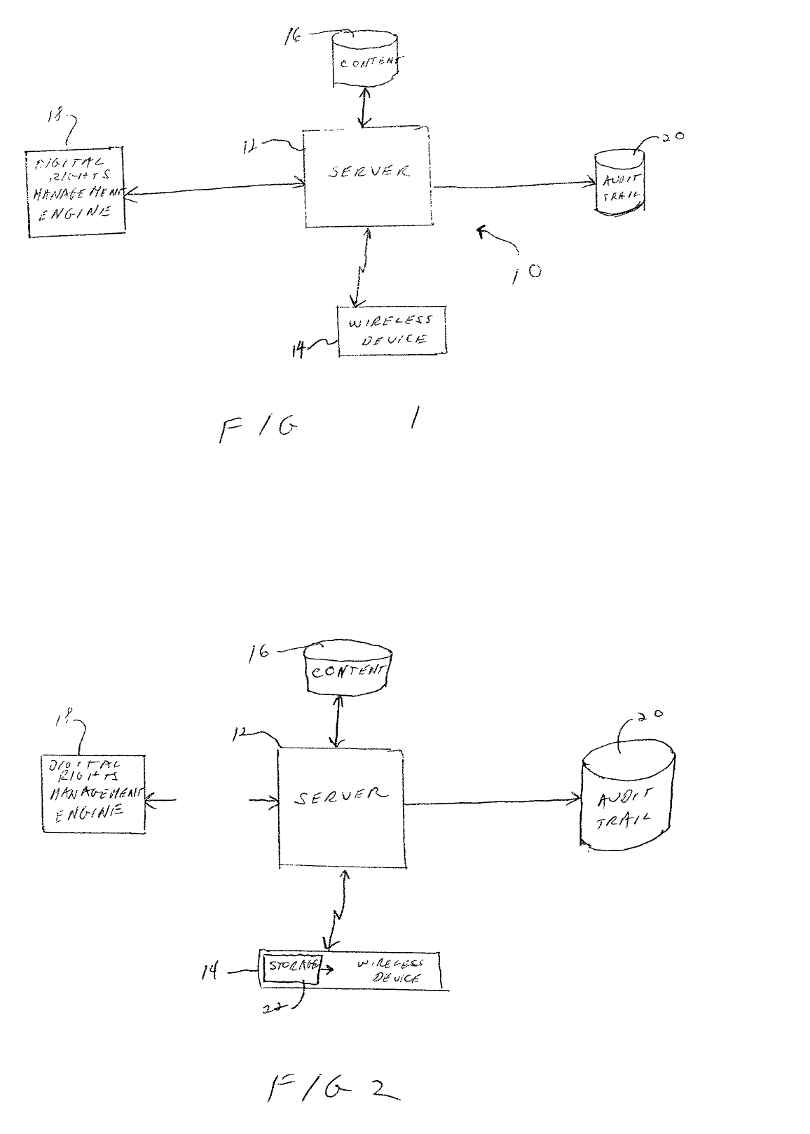

Referring now to the drawings, wherein like reference numerals designate identical or corresponding parts throughout the several views, and more particularly to FIG. 1 thereof, wherein the present system 10 is shown as including a central server 12 which includes a trusted lock. The server is connected wirelessly to wireless device 14 which is in the hands of the user. The server is also connected to a storage device 16 which contains data including copyrighted material. This may be in encrypted format as necessary. The server is also connected to a digital rights management engine 18 which determines the appropriate rights connected to each part of the data content and whether the requesting party has appropriate rights thereto. An audit trail storage device 20 is also connected to the server.

Thus, in operation, the user uses wireless device 14 to contact server 12. An authentication method is performed using known mechanisms such as the Diffie-Helmann Exchange of Secrets. Once both parties are sure of the identity of the other, the terminal may request data to be sent. This data may be the next page in an electronic book when the user presses a next page button or may be a request for the next 30 seconds of a song or video that is running on the terminal. The server receives the request and records situation information such as the time of request and passes the request onto the digital rights management engine. This engine them compares the request with its stored knowledge of the users right to access the copyrighted material. If the user has sufficient rights, authorization is provided to the server. When the server receives authorization, it is recorded in the audit trail storage device. This storage may not be modified. The information as stored therein is used to make charges where appropriate to the user. At the same time, the data is formatted and delivered to the wireless device for use.

FIG. 2 shows a second embodiment which operates in the same fashion but where the available bandwidth is smaller. In this case, the wireless device 14 also contains a storage unit 22. Since the bandwidth is not high enough to maintain delivery of the content, the content is instead delivered at one time to the storage device 22 through the server and wireless connection. Instructions are then provided by the server to the storage unit to forward the information as it can be used. This wireless device otherwise operates in the same manner as the wireless device in FIG. 1.

Likewise, the other devices operate in the same fashion as the first embodiment.

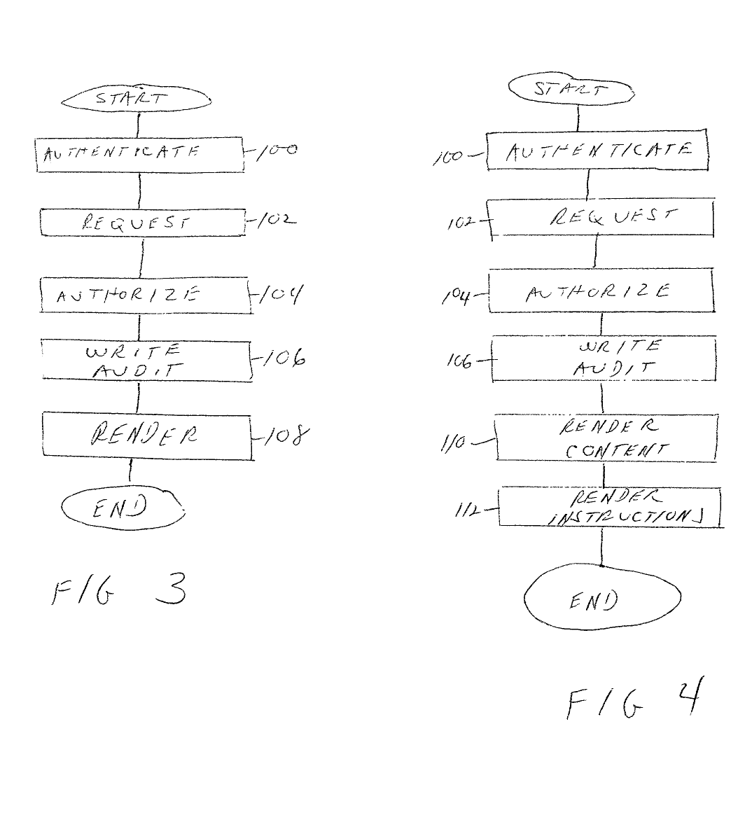

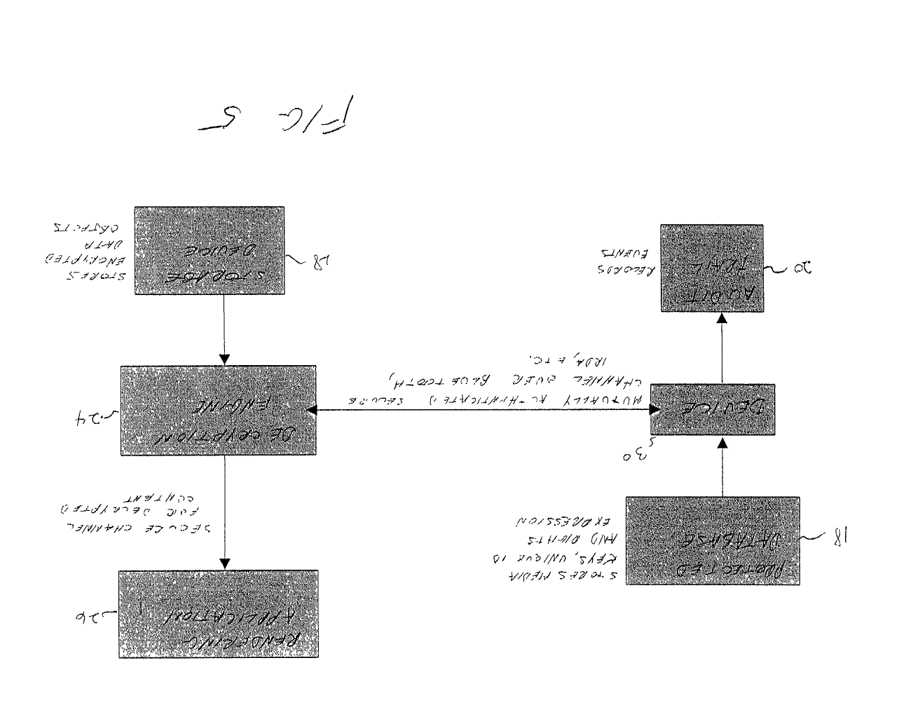

FIG. 3 is a flowchart showing the steps involved in the first embodiment. In step 100, the wireless device and the server mutually authenticate the identity of each other. In step 102, a request is given by the user and received by the server. It is then passed on to the digital rights management engine. In step 104, the authorization is rendered by the digital rights management engine to the server. The authorization is stored in the audit trail storage device in step 106. The content is then rendered by the server in step 108.

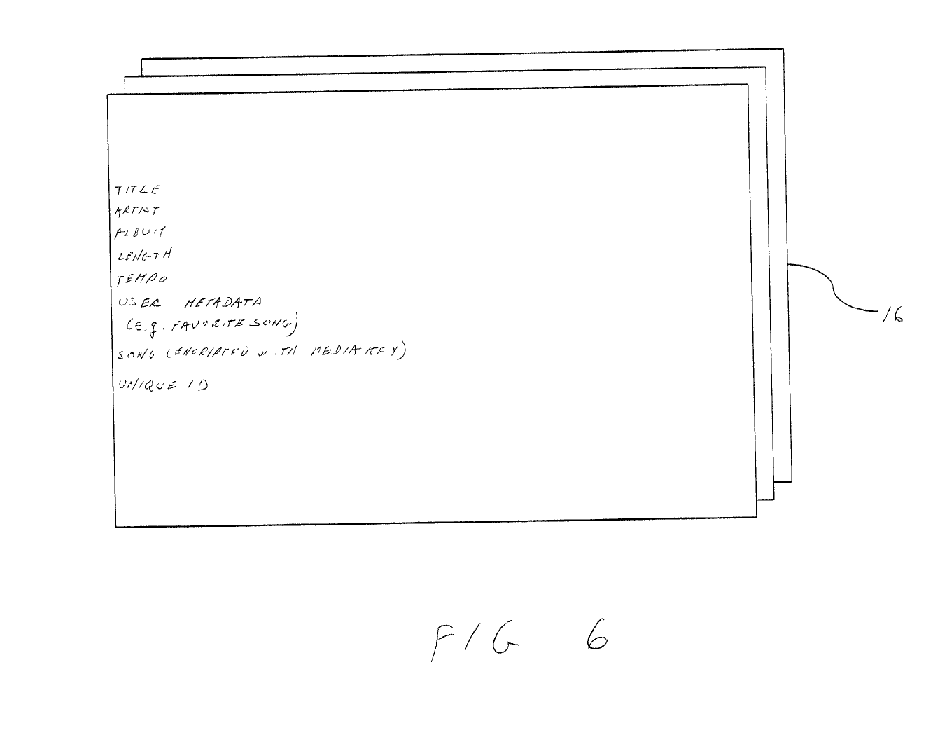

FIG. 4 is a flowchart showing the steps of the method used in the embodiment of FIG. 2. Steps 100 to 106 operate in the same fashion as similarly numbered steps in FIG. 3. However, the final step of rendering the information 108 has been replaced by two steps 110 and 112. In step 110 the content is first rendered and stored in storage device 22. In the final step, instructions are then provided to forward as necessary data from the storage device 22.

FIG. 5 shows another arrangement of the system and its functional connections. The protected data base 18 stores the immediate keys, the unique ID numbers and the rights expression. This information is fed to the server device 30 and an audit trail 20 is generated which records events. The device 30 is connected to the decryption engine 24 in a wireless device. A mutually authenticated secure channel is generated using some type of wireless connection such as Blue Tooth, IRDA, or other wireless connections. Storage device 28 stores encrypted data objects which are sent to the decryption engine. Data which has been decrypted is then sent to the rendering application 26 along the secure channel for the decrypted data content.

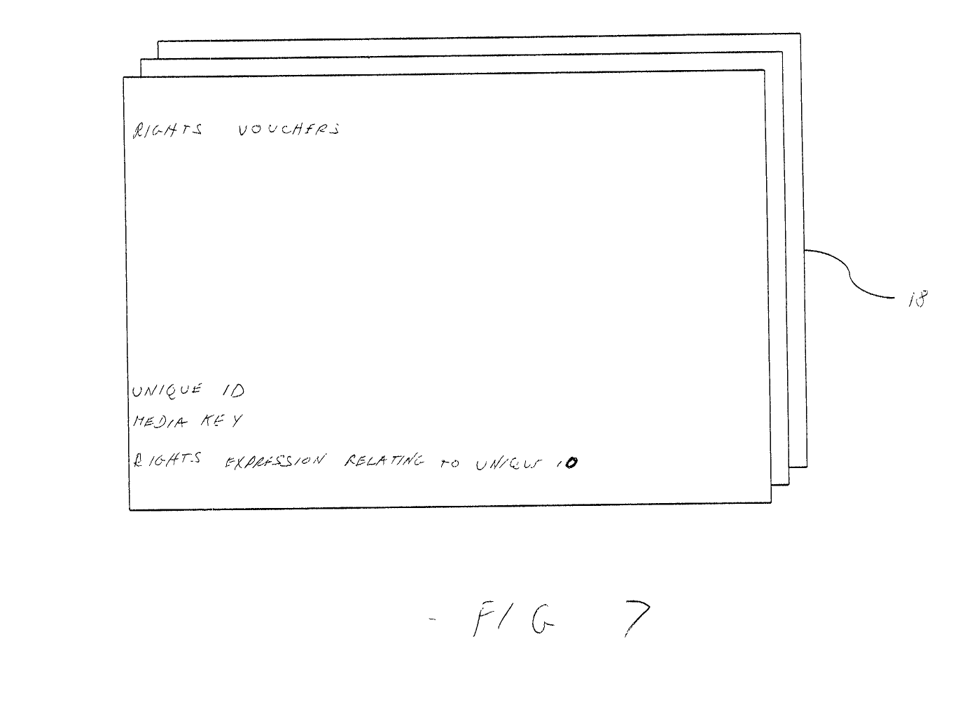

FIG. 6 is a diagram which shows files in the content storage device and how the data is arranged. That is, for each song or other copyrighted data which is stored, the file includes information about the title, artist, album, length, tempo, user, metadata and the song or other copyrighted information which is encrypted with the media key. A unique identifier is also stored

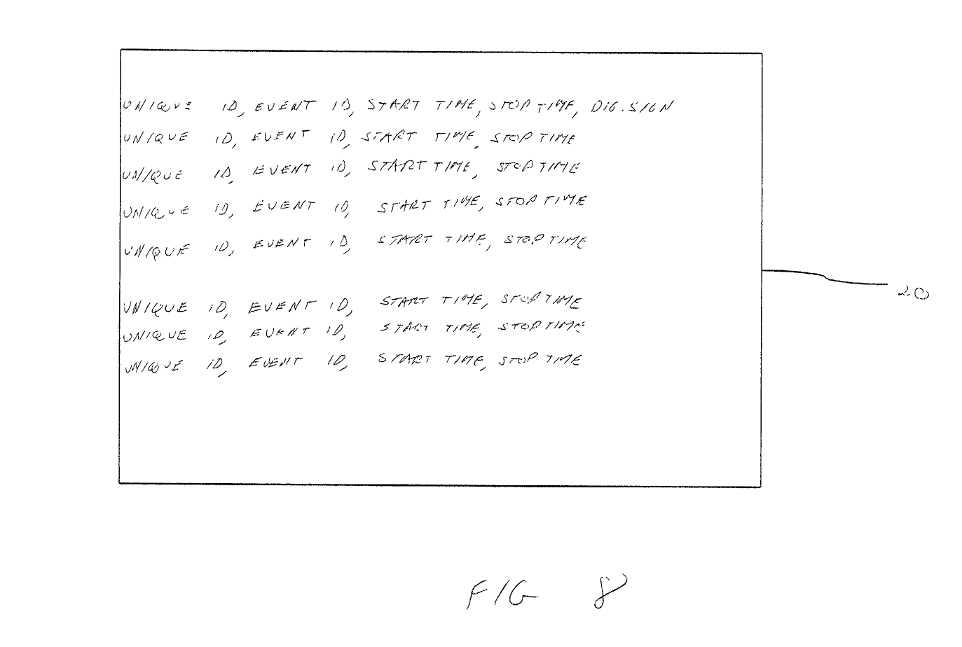

FIG. 7 shows the filing arrangement of data in the digital rights management engine 18. Thus for each user, a file is kept which has a unique identifier, a media key and rights expression relating to the unique ID. The file also establishes rights vouchers for that person.

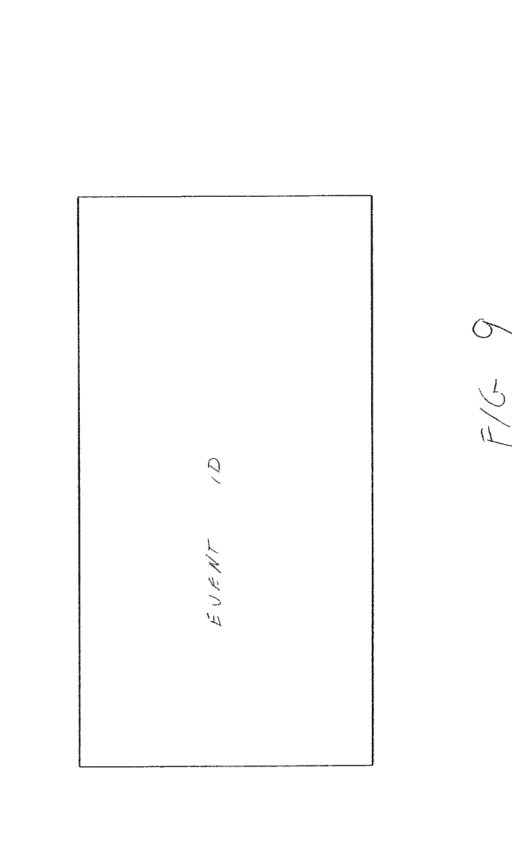

FIG. 8 shows a file in the audit trail 20 which lists for each movement of data, the unique identifier, the event identifier, the start and stop times and the digital signature.

FIG. 9 is a diagram showing the storage of the event ID in a file.

The advantage of the present system is that the wireless device avoids the need for high storage and processing capability. Especially in the embodiment of FIG. 1, the wireless device only needs an authentication engine and simple communications systems. The remainder of the operation is done in the server which does not have space limitations and which can be made very secure. In addition, this type of system works very well with a wireless “always on” connection. The result of this arrangement is additional security, fewer demands on the capabilities of the terminal and improved service to the user.

Once the terminal and server have been mutually authenticated, other trusted services such as timing, auditing and copying can be triggered from the terminal and run on the server. The resulting authorization is sent to the client in accordance with the digital rights management engine. The audit trails are stored to enable billing mechanisms. By relying on the server to have trusted services such as timing, auditing and copying, it is not necessary to build costly components into the terminal so that the terminals may be more secure and be provided at a lower cost. By providing these trusted services and a digital rights management engine on the server, the terminal is no longer required to utilize CPU intensive computations and further has lower storage and memory requirements. Since the sensitive authorization operations are performed in a trusted environment on the server, the wireless devices can be more secure and lightweight.

The present system is especially useful when wireless networks are very widespread. Such networks may be of any speed depending on the complexity of the terminal. A lower speed network would require components such as trusted storage. A higher bandwidth environment will allow the terminal to be very simple and “thin”, requiring little more than a display, battery and appropriate communications circuitry.

In both FIGS. 1 and 2, server 12 would normally be different from the server which controls the wireless network. However, it is possible that it would sit in the same box if appropriate for the arrangement of the network. It should also be remembered that this type of system could be used in a wired network although the advantages gained thereby are not as important as in a wireless network.

By having as many functions as possible in the central server and digital rights management engine, where they are safer, the size of the terminal may be reduced. In addition, it is more secure in this fashion. Thus, the server and engine are in a safe location and not in the hostile environment of the user. Also other features such as time metering are more available to the server which has faster speed, more power storage and bandwidth than can be utilized in a hand held device.

Furthermore, it is possible for the user to add modifications easily. Thus, if the rights are saved on the server it is possible to use a different wireless device and still gain access to the material. For example, if you wish to watch a movie at a friend's house because of their large TV, it can be accessed from their location and using their equipment.

It is also possible to allow further features such as copying, giving or lending of copyrighted material from one consumer to another. This can be done by a first person browsing a second persons music selection to which the second person has rights. The first offers to either borrow or receive as a gift or purchase the content from the second. The rights of the second user are transferred to the first while the second is paid by the first, possibly with a profit.

In the second embodiment, while the content has been shown as being moved to storage 22 by way of the wireless system, it is also possible to move it by other means such as by Bluetooth or DVB-T.

1. A system for communicating data and protecting rights therein, comprising:
at least one user device for receiving data;
a server in communication with said at least one user device and including a trusted lock;
a rights management engine for determining user rights in said data;
a storage device for storing said data; and
a storage device for recording an audit trail.

2. A system according to claim 1, wherein said server, rights management engine, data storage and audit trail storage are in a secure location separate from the user device so that trusted services including trusted timing, auditing and copying are performed in a secure environment.

3. The system according to claim 1, wherein said user device includes a storage device for holding data which is released under instructions from said server.

4. The system according to claim 1, wherein said server and user device are connected through a wireless connection.

5. The system according to claim 4, wherein said wireless connection is an “always on” connection.

6. A method of communicating data from a server to a user device and protecting rights therein, comprising:
authenticating identification of said server and said user device;
requesting data to be communicated;
authorizing said data to be communicated based on rights attributed to said user device;
recording said authorization to provide for billing information and an audit trail;
communicating said data to said user device.

7. The method according to claim 6, wherein said data is communicated to said user device and stored therein and rendered in sections according to instructions communicated from said server.

8. The method according to claim 6, wherein communication between said server and said user device is a wireless communication.

9. The method according to claim 8, wherein said wireless communication is an “always on” connection.

10. The method according to claim 6, wherein said authorization step is performed by a digital rights management engine in communication with said server.

11. The method according to claim 6, wherein said recording step is performed in a storage device to record authorization along with time and other information in order to provide a trusted audit trail, which is based on trusted time and a trusted third party to sign the recording.

12. The method according to claim 6, wherein said data is originally stored in a content storage device connected to said server.

13. A rights secure communication device for providing data to a user device comprising:
a server;
a data storage device connected to said server for storing said data; and
a digital rights management engine connected to said server for determining rights attributed to users.

14. The communication device according to claim 13, further comprising a secure storage device for recording authorization of data communication in a secure audit trail.

15. The communication device according to claim 13, wherein data is sent from said server to a user through a wireless communication system.

16. The communication device according to claim 15, wherein said wireless communication system is a “always on” connection.

17. A mobile terminal system for receiving protected data, comprising:
a wireless connection including a transmitter and receiver for communicating with a server which stores protected data, stores data relating to rights to use said protected data and the storage device for recording transactions relating to said protected data;
a decryption engine for decrypting encrypted data sent from said server through said wireless connection;
a display device for displaying said protected data to a user of said mobile terminal.

18. The method according to claim 17, wherein said mobile terminal includes a data storage device for temporarily storing protected data.

19. A computer program embodied on a computer readable medium and executable by a computer to communicate data having protected rights, comprising:
communicating wirelessly with a mobile terminal controlled by a user;
determining rights of said user in protected data using a rights management engine;
recording an audit trail of communications with said mobile terminal in a storage device.

20. A computer program according to claim 19, further comprising storing said protected data in a secure location separate from said mobile terminal wherein all operations regarding said protected data are performed in a secure environment.
